(19) United States
(12) Patent Application Publication
(10) Pub. No.: US 2025/0004400 A1
(43) Pub. Date: Jan. 2, 2025

(54) DEVELOPING DEVICE AND IMAGE FORMING APPARATUS

(71) Applicant: FUJIFILM Business Innovation Corp., Tokyo (JP)

(72) Inventors: Kiyoshi Sako, Kanagawa (JP); Takashi Sakamoto, Kanagawa (JP); Takuya Iwamura, Kanagawa (JP); Taichiro Okuno, Kanagawa (JP); Masayuki Shimoda, Kanagawa (JP); Kento Terashima, Kanagawa (JP); Kenji Hayamizu, Kanagawa (JP)

(73) Assignee: FUJIFILM Business Innovation Corp., Tokyo (JP)

(21) Appl. No.: 18/532,199

(22) Filed: Dec. 7, 2023

(30) Foreign Application Priority Data
Jun. 29, 2023 (JP) 2023-106569

(51) Int. Cl. G03G 15/08

(52) U.S. Cl. CPC G03G 15/0893; G03G 15/0889; G03G 2215/085

(57) ABSTRACT

A developing device includes: a developer transport unit that transports a developer containing a toner and a carrier; and a developer discharge unit provided at an end portion on a downstream side along a transport direction of the developer transport unit and including a reverse transport blade that is disposed inside a reversing passage from which a part of the developer is discharged, and rotates around a rotation shaft to transport the developer in a direction opposite to a discharge direction, the developer discharge unit including a magnetic attraction unit magnetically attracting the developer in at least one of the reverse transport blade or the reversing passage.

### CROSS-REFERENCE TO RELATED APPLICATIONS

This application is based on and claims priority under 35 USC 119 from Japanese Patent Application No. 2023-106569 filed Jun. 29, 2023.

### BACKGROUND

### (i) Technical Field

The present invention relates to a developing device and an image forming apparatus.

### (ii) Related Art

Conventionally, as techniques related to a developing device, for example, those disclosed in JP2021-039287A and JP1993-323782A (JP-H05-323782A) are already proposed.

JP2021-039287A discloses a developing device provided with a magnetic field generation portion disposed on a downstream side of an upstream end of a discharge port in a direction in which a developer is conveyed in a discharge conveyance portion.

JP1993-323782A (JP-H05-323782A) discloses a developing machine in which including a rotary paddle for stirring a developer including a toner and a carrier, in which a magnet for magnetically attracting the developer accumulated in a lower portion of a developing machine case is provided inside the rotary paddle.

### SUMMARY

Aspects of non-limiting embodiments of the present disclosure relate to a developing device that suppresses a variation in the amount of a developer in a developing device caused by discharge of the developer from a developer discharge unit due to a change in a toner concentration of the developer in the developing device as compared with a case where the developer discharge unit having a magnetic attraction unit that magnetically attracts the developer in at least one of a reverse transport blade or a reversing passage is not provided.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device comprising:

a developer transport unit that transports a developer containing a toner and a carrier; and

a developer discharge unit provided at an end portion on a downstream side along a transport direction of the developer transport unit and including a reverse transport blade that is disposed inside a reversing passage from which a part of the developer is discharged, and rotates around a rotation shaft to transport the developer in a direction opposite to a discharge direction, the developer discharge unit including a magnetic attraction unit magnetically attracting the developer in at least one of the reverse transport blade or the reversing passage.

### BRIEF DESCRIPTION OF THE DRAWINGS

FIG. 1 is a diagram illustrating an overall configuration of an image forming apparatus to which a developing device according to a first embodiment of the present invention is applied.

FIG. 2 is a diagram illustrating a configuration of an image forming section of the image forming apparatus to which the developing device according to the first embodiment of the present invention is applied.

FIG. 3 is a longitudinal cross-sectional view illustrating a configuration of the developing device according to the first embodiment of the present invention.

FIG. 4 is a plan view illustrating the configuration of the developing device according to the first embodiment of the present invention.

FIG. 5 is a plan view illustrating a configuration of the main portion of the developing device according to the first embodiment of the present invention.

FIG. 6 is a perspective view illustrating a configuration of a reverse transport blade.

FIGS. 7A and 7B are diagrams illustrating the configuration of the reverse transport blade.

FIG. 8 is a cross-sectional view illustrating a distal end portion of the reverse transport blade.

FIGS. 9A to 9C are diagrams illustrating the configuration of the reverse transport blade.

FIG. 10 is a schematic diagram illustrating a developer adhering to the reverse transport blade when a toner concentration is low.

FIG. 11 is an explanatory diagram illustrating a state of the developer discharged to the outside by the reverse transport blade when the toner concentration is low in the developing device according to the first embodiment of the present invention.

FIG. 12 is a schematic diagram illustrating the developer adhering to the reverse transport blade when the toner concentration is high.

FIG. 13 is an explanatory diagram illustrating a state of the developer discharged to the outside by the reverse transport blade when the toner concentration is high in the developing device according to the first embodiment of the present invention.

FIG. 14 is a cross-sectional view illustrating a configuration of the main portion of a developing device according to a second embodiment of the present invention.

FIG. 15 is a plan view illustrating a configuration of the main portion of the developing device according to the second embodiment of the present invention.

FIG. 16 is a cross-sectional view illustrating a configuration of a magnet.

FIG. 17 is a schematic diagram illustrating a developer adhering to a reversing passage when a toner concentration is low in the developing device according to the second embodiment of the present invention.

FIG. 18 is an explanatory diagram illustrating a state of the developer discharged to the outside by a reverse screw auger when the toner concentration is low in the developing device according to the second embodiment of the present invention.

FIG. 19 is a schematic diagram illustrating the developer adhering to the reversing passage when the toner concentration is high.

FIG. 20 is an explanatory diagram illustrating a state of the developer discharged to the outside by the reverse screw auger when the toner concentration is high in the developing device according to the second embodiment of the present invention.

### DETAILED DESCRIPTION

Hereinafter, modes for carrying out the present invention (hereinafter, referred to as “embodiments”) will be described with reference to the drawings.

### First Embodiment

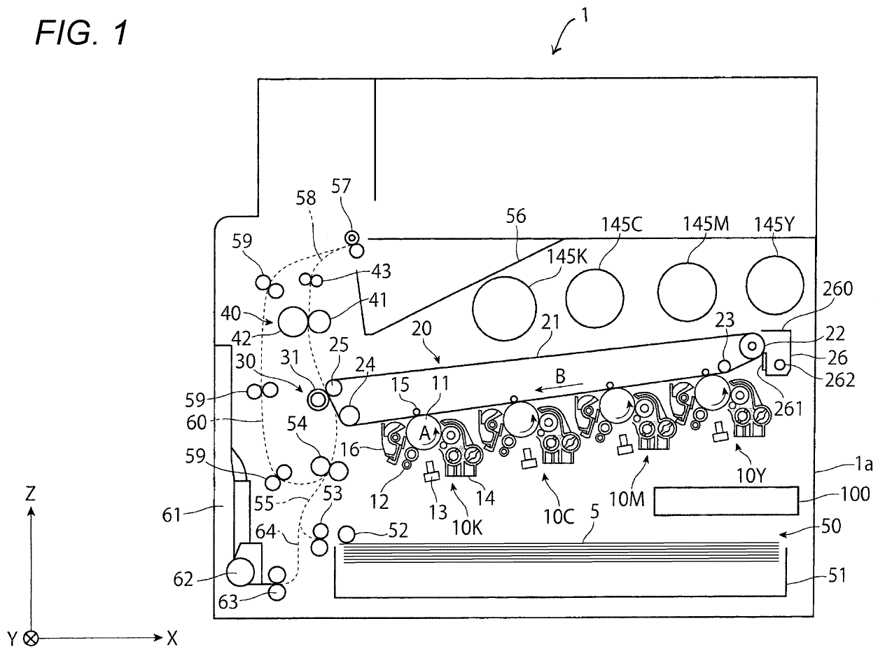

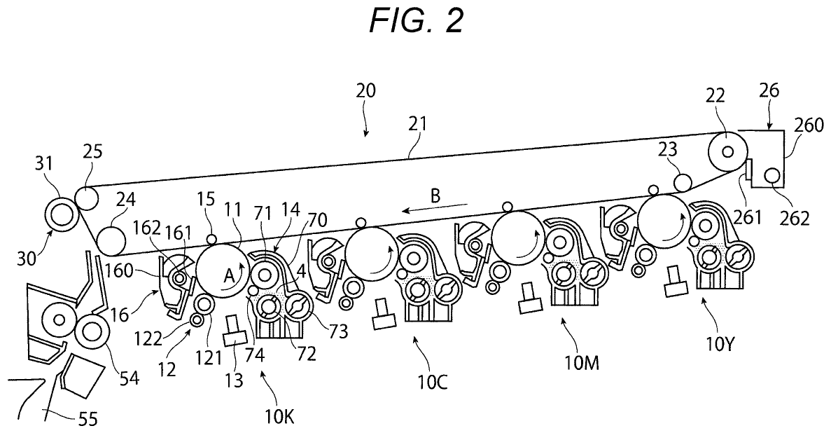

FIGS. 1 and 2 each illustrate an image forming apparatus to which a developing device according to a first embodiment is applied. FIG. 1 illustrates an overall overview of the image forming apparatus, and FIG. 2 illustrates the main portion (including an image forming device or the like) of the image forming apparatus in an enlarged manner. In FIG. 1, reference X denotes a horizontal direction (width direction) of the image forming apparatus, reference Y denotes a depth direction of the image forming apparatus, and reference Z denotes a vertical direction of the image forming apparatus.

### <Overall Configuration of Image Forming Apparatus>

The image forming apparatus 1 according to the first embodiment is configured as, for example, a color printer. The image forming apparatus 1 includes, in the apparatus body 1a, a plurality of image forming devices 10 that form toner images to be developed with toners constituting a developer 4, an intermediate transfer device 20 that holds the toner images respectively formed by the image forming devices 10 and transports the toner images to a secondary transfer position at which the toner images are secondarily transferred onto a recording sheet 5 finally, which is an example of a recording medium, a sheet feeding device 50 that accommodates and transports the predetermined recording sheet 5 that needs to be supplied to the secondary transfer position of the intermediate transfer device 20, and a fixing device 40 that fixes the toner images secondarily transferred onto the recording sheet 5 by the intermediate transfer device 20. Note that the apparatus body 1a of the image forming apparatus 1 is formed by a supporting structural member, an exterior cover, and the like.

The image forming devices 10 include four image forming devices 10Y, 10M, 10C, and 10K that dedicatedly form toner images of four colors of yellow (Y), magenta (M), cyan (C), and black (K), respectively. These four image forming devices 10 (Y, M, C, and K) are disposed to be aligned in a line in a state of being inclined in the internal space of the apparatus body 1a. Among the four image forming devices 10 (Y, M, C, and K), the image forming device 10Y for yellow (Y) is located at an upper position in the vertical direction Z and is relatively high, and the image forming device 10K for black (K) is located at a relatively low position.

As illustrated in FIGS. 1 and 2, each of the image forming devices 10 (Y, M, C, and K) for yellow (Y), magenta (M), cyan (C), and black (K) includes a rotating photosensitive drum 11, which is an example of an image holding unit that holds an electrostatic latent image, and the following devices, which are examples of a toner image forming unit, are mainly disposed around the photosensitive drum 11. The main devices include: a charging device 12 that charges a peripheral surface (image holding surface) of the photosensitive drum 11 on which an image can be formed to a predetermined potential; an exposure device 13 that forms an electrostatic latent image for each color with a potential difference by irradiating the charged peripheral surface of the photosensitive drum 11 with light based on image information (signal); a developing device 14 (Y, M, C, or K) which is an example of a developing unit that develops the electrostatic latent image into a toner image with the toner of the developer 4 of the corresponding color (Y, M, C, or K); a primary transfer device 15 (Y, M, C, or K) that transfers the toner image to the intermediate transfer device 20; and a drum cleaning device 16 (Y, M, C, or K) that cleans the image holding surface of the photosensitive drum 11 by removing extraneous matter such as a toner remaining and adhering to the image holding surface after primary transfer.

The photosensitive drum 11 is obtained by forming the image holding surface having a photoconductive layer (photosensitive layer) made of a photosensitive material on a peripheral surface of a grounded cylindrical or columnar substrate. The photosensitive drum 11 is supported so as to rotate in a direction indicated by an arrow A by power transmitted from a driving device (not illustrated).

The charging device 12 includes a contact-type charging roller 121 that is disposed in contact with the photosensitive drum 11 as illustrated in FIG. 2. A cleaning roller 122 that cleans a surface of the charging roller 121 is disposed behind the charging roller 121. A charging voltage is supplied to the charging roller 121 of the charging device 12. In a case where the developing device 14 performs reversal development, a voltage or a current having the same polarity as a charging polarity of the toner supplied from the developing device 14 is supplied as the charging voltage. Note that a non-contact-type charging device such as a scorotron disposed in a non-contact state with the surface of the photosensitive drum 11 may be used as the charging device 12.

The exposure device 13 forms the electrostatic latent image by irradiating the charged peripheral surface of the photosensitive drum 11 with light formed in accordance with the image information input to the image forming apparatus 1. The image information (signal) input in any manner to the image forming apparatus 1 is transmitted to the exposure device 13 at the time of forming the latent image.

The exposure device 13 includes a light emitting diode (LED) print head that forms the electrostatic latent image by irradiating the photosensitive drum 11 with the light in accordance with the image information using LEDs serving as a plurality of light emitting elements arrayed along an axial direction of the photosensitive drum 11. Note that a device that deflects and scans a laser beam formed in accordance with the image information along the axial direction of the photosensitive drum 11 may be used as the exposure device 13.

Each of the developing devices 14 (Y, M, C, and K) includes, inside the housing 70 in which an opening at a position opposing the photosensitive drum 11 and a developer accommodating chamber are formed, a developing roller 71 that holds the developer 4 and transports the developer 4 to a development region facing the photosensitive drum 11, a stirring supply member 72 including a screw auger or the like that supplies the developer 4 to pass through the developing roller 71 while stirring the developer 4, a stirring transport member 73 including a screw auger or the like that transports the developer 4 to the stirring supply member 72 while stirring the developer 4, and a layer thickness regulating member 74 that regulates the amount (layer thickness) of the developer held by the developing roller 71. In the developing device 14, a developing voltage is supplied between the developing roller 71 and the photosensitive drum 11 from a power supply device (not illustrated). As the developer 4 of each color, for example, a two-component developer containing a non-magnetic toner and a carrier is used. Note that the configuration of the developing device 14 will be described in detail later.

Each of the primary transfer devices 15 (Y, M, C, and K) is a contact-type transfer device including a primary transfer roller which rotates in contact with the periphery of the photosensitive drum 11 with the intermediate transfer belt 21 interposed therebetween and to which a primary transfer voltage is supplied. As the primary transfer voltage, a direct-current voltage having a polarity opposite to the charging polarity of the toner is supplied from the power supply device (not illustrated).

As illustrated in FIG. 2, each of the drum cleaning devices 16 (Y, M, C, and K) includes: a container-shaped body 160 having a portion that is open, a cleaning plate 161 that is disposed to come into contact with the peripheral surface of the photosensitive drum 11 after primary transfer at a predetermined pressure and removes extraneous matter, such as a residual toner, to perform cleaning; and a sending member 162, such as a screw auger, that collects the extraneous matter, such as the toner, removed by the cleaning plate 161 and transports the collected extraneous matter to be sent to a collecting system (not illustrated). A plate member (for example, a blade) made of a material such as rubber is used as the cleaning blade 161.

As illustrated in FIG. 1, the intermediate transfer device 20 is disposed at a position above the respective image forming devices 10 (Y, M, C, and K). As illustrated in FIG. 2, the intermediate transfer device 20 mainly includes: the intermediate transfer belt 21 that rotates in a direction indicated by an arrow B while passing through a primary transfer position between the photosensitive drum 11 and the primary transfer device 15; a plurality of belt support rollers 22 to 25 that hold the intermediate transfer belt 21 in a desired state from its inner surface and rotatably support the intermediate transfer belt 21; a secondary transfer device 30 that is disposed on a side of an outer peripheral surface (the image holding surface) of the intermediate transfer belt 21 supported by the belt support rollers 25 and secondarily transfers the toner images on the intermediate transfer belt 21 onto the recording sheet 5; and a belt cleaning device 26 performs cleaning by removing extraneous matter such as a toner and paper dust remaining on and adhering to the outer peripheral surface of the intermediate transfer belt 21 after passing through the secondary transfer device 30.

As the intermediate transfer belt 21, for example, an endless belt made of a material in which a resistance adjusting agent such as carbon black is dispersed in a synthetic resin such as a polyimide resin or a polyamide resin is used. In addition, the belt support roller 22 is configured as a driving roller that is rotationally driven by a driving device (not illustrated) and a support roller of the belt cleaning device 26, the belt support roller 23 is configured as a surface forming roller that holds a traveling position of the intermediate transfer belt 21, the belt support roller 24 is configured as a tension applying roller that applies tension to the intermediate transfer belt 21, and the belt support roller 25 is configured as a backup roller for secondary transfer.

As illustrated in FIG. 1, the secondary transfer device 30 is a contact-type transfer device including a secondary transfer roller 31 which rotates in contact with the peripheral surface of the intermediate transfer belt 21 at the secondary transfer position, which is an outer peripheral surface portion of the intermediate transfer belt 21 supported by the belt support roller 25 in the intermediate transfer device 20 and to which a secondary transfer voltage is supplied. In addition, a direct-current voltage having a polarity opposite to or the same as the charging polarity of the toner is supplied as the secondary transfer voltage to the secondary transfer roller 31 or the belt support roller 25 of the intermediate transfer device 20.

The belt cleaning device 26 includes: a container-shaped body 260 having a portion that is open; a cleaning plate 261 that is disposed to come into contact with the peripheral surface of the intermediate transfer belt 21 after the secondary transfer at a predetermined pressure and removes extraneous matter, such as a residual toner, to perform cleaning; and a sending member 262, such as a screw auger, that collects the extraneous matter, such as the toner, removed by the cleaning plate 261 and transports the collected extraneous matter to be sent to a collecting system (not illustrated). A plate member (for example, a blade) made of a material such as rubber is used as the cleaning plate 261.

As illustrated in FIG. 1, the fixing device 40 is configured by arranging a drum-shaped or belt-shaped heating rotating body 41 that is heated by a heater such that a surface temperature is maintained at a predetermined temperature, a drum-shaped or belt-shaped pressing rotating body 42 that rotates in contact with the heating rotating body 41 at a predetermined pressure substantially along an axial direction of the heating rotating body 41, and the like. In the fixing device 40, a contact portion where the heating rotating body 41 and the pressing rotating body 42 are in contact with each other serves as a fixing processor that performs a predetermined fixing process (heating and pressing). Note that an exit roller 43 that transports the recording sheet 5 that has been subjected to the fixing process in the fixing device 40 is disposed at an exit of the fixing device 40.

The sheet feeding device 50 is disposed at a position below the image forming devices 10 (Y, M, C, and K) of yellow (Y), magenta (M), cyan (C), and black (K). The sheet feeding device 50 includes a single sheet accommodating body (or a plurality of sheet accommodating bodies) 51 that accommodates the recording sheets 5 of desired size and type in a stacked manner, and sending devices 52 and 53 that send the recording sheets 5 one by one from the sheet accommodating body 51. The sheet accommodating body 51 is attached so as to be capable of being pulled out to, for example, a front side (a surface facing a user during operation) of an apparatus body 1a, that is, a front surface (front) side in the depth direction Y perpendicular to the paper plane in the illustrated example.

Examples of the recording sheet 5 include plain paper, thin paper, and an overhead projector (OHP) sheet used in an electrophotographic copying machine, a printer, or the like. In order to further improve smoothness of an image surface after fixing, a surface of the recording sheet 5 is also preferably as smooth as possible, and it is also possible to use, for example, coated paper obtained by coating a surface of plain paper with a resin or the like, so-called thick paper having a relatively large basis weight such as art paper for printing, or the like.

A sheet feeding transport path 55 including a single sheet transport roller pair (or a plurality of sheet transport roller pairs) 54 that transports the recording sheet 5 sent from the sheet feeding device 50 to the secondary transfer position, a transport guide (not illustrated), and the like is provided between the sheet feeding device 50 and the secondary transfer device 30 as illustrated in FIG. 1. The sheet transport roller pair 54 disposed immediately before the secondary transfer device 30 is configured as, for example, registration rollers that adjusts a transport timing of the recording sheet 5. In addition, a sheet discharge transport path 58, which includes a sheet discharge roller pair 57 for discharging the recording sheet 5 after fixing, which is sent from the exit roller 43 of the fixing device 40, to a discharge tray 56 provided in an upper portion of the apparatus body 1a, is provided in an upper portion of the fixing device 40 along the vertical direction Z.

In addition, a duplex transport path 60 including a plurality of duplex transport roller pairs 59, which switch a rotation direction of the sheet discharge roller pair 57 from a normal rotation direction (discharge direction) to a reverse rotation direction while the sheet discharge roller pair 57 holds a trailing end of the recording sheet 5 having an image formed on one side thereof to reverse the front and back of the recording sheet 5 and transport the recording sheet 5 again to the sheet transport roller pair 54, is provided inside the apparatus body 1a.

In FIG. 1, reference 61 denotes a manual feed tray that is openably and closably provided on a side surface (left side surface in FIG. 1) of the apparatus body 1a of the image forming apparatus 1, and a sending device 62 that sends the recording sheets 5 accommodated in the manual feed tray 61 one by one and a manual sheet feeding transport path 64 including a sheet transport roller pair 63 and a transport guide (not illustrated) are provided between the manual feed tray 61 and the sheet transport roller pair 54.

In addition, references 145 (Y, M, C, and K) in FIG. 1 denote a plurality of toner cartridges arrayed along the horizontal direction X and containing developers each containing at least a toner and a carrier to be supplied to the corresponding developing devices 14 (Y, M, C, and K). In the first embodiment, the toner cartridges 145 (Y, M, C, and K) contain toners containing carriers. A percentage of the carrier contained in the toner is set to a value smaller than that of the developer 4 in the developing device 14 (Y, M, C, or K).

In FIG. 1, reference 100 denotes a control device that integrally controls the operation of the image forming apparatus 1. The control device 100 includes a central processing unit (CPU), a read only memory (ROM), a random access memory (RAM), a bus that connects the CPU, the ROM, and the like, a communication interface, and the like, which are not illustrated.

### <Operation of Image Forming Apparatus>

Hereinafter, a basic image forming operation performed by the image forming apparatus 1 will be described.

Here, an operation of forming a full-color image, formed by combining toner images of four colors (Y, M, C, and K), using the four image forming devices 10 (Y, M, C, and K) will be described.

In the image forming apparatus 1, the four image forming devices 10 (Y, M, C, and K), the intermediate transfer device 20, the secondary transfer device 30, the fixing device 40, and the like are started when the control device 100 receives instruction information of a request for an image forming operation (printing).

In each of the image forming devices 10 (Y, M, C, and K), each of the photosensitive drums 11 first rotates in the direction indicated by the arrow A, and each of the charging devices 12 charges the surface of each of the photosensitive drums 11 to a predetermined polarity (negative polarity in the first embodiment) and a predetermined potential. Subsequently, the exposure device 13 irradiates the charged surface of the photosensitive drum 11 with light emitted based on an image signal, obtained by converting image information input to the image forming apparatus 1 into each of color components (Y, M, C, and K), and forms an electrostatic latent image of each of the color components having a predetermined potential difference on the surface.

Subsequently, each of the image forming devices 10 (Y, M, C, and K) performs development by supplying, from the developing roller 71, a toner of a corresponding color (Y, M, C, or K) electrostatically charged to a predetermined polarity (negative polarity) to electrostatically adhere to the electrostatic latent image of each of the color components formed on the photosensitive drum 11. Through this development, the electrostatic latent images of the respective color components formed on the respective photosensitive drums 11 are visualized as toner images of four colors (Y, M, C, and K that have been developed using the toners of the corresponding colors.

Subsequently, when the toner images of the respective colors formed on the photosensitive drums 11 of the respective image forming devices 10 (Y, M, C, and K) are transported to the primary transfer position, the primary transfer devices 15 (Y, M, C, and K) primarily transfer the toner images of the respective colors to be sequentially superposed on the intermediate transfer belt 21 of the intermediate transfer device 20 rotating in the direction indicated by the arrow B.

In addition, in each of the image forming devices 10 (Y, M, C, and K) which have finished the primary transfer, the drum cleaning device 16 scrapes off and removes extraneous matter to clean the surface of the photosensitive drum 11. As a result, each of the image forming devices 10 (Y, M, C, and K) is brought into a state where the next image forming operation can be performed.

Subsequently, in the intermediate transfer device 20, the toner images primarily transferred by the rotation of the intermediate transfer belt 21 are held and transported to the secondary transfer position. On the other hand, the sheet feeding device 50 sends a predetermined recording sheet 5 to the sheet feeding transport path 55 in accordance with the image forming operation. In the sheet feeding transport path 55, the sheet transport roller pair 54 serving as the registration rollers send and supply the recording sheet 5 to the secondary transfer position in accordance with a transfer timing.

At the secondary transfer position, the secondary transfer roller 31 of the secondary transfer device 30 secondarily transfers the toner images on the intermediate transfer belt 21 onto the recording sheet 5 collectively. In addition, in the intermediate transfer device 20 that has finished the secondary transfer, the belt cleaning device 26 performs cleaning by removing extraneous matter such as a toner remaining on the surface of the intermediate transfer belt 21 after the secondary transfer.

Subsequently, the recording sheet 5 onto which the toner images have been secondarily transferred is peeled off from the intermediate transfer belt 21 and the secondary transfer roller 31, and then, transported to the fixing device 40. In the fixing device 40, the recording sheet 5 after the secondary transfer is introduced into and passes through the contact portion between the heating rotating body 41 and the pressing rotating body 42, which are rotating, to be subjected to a necessary fixing process (heating and pressing), whereby the unfixed toner images are fixed to the recording sheet 5. When the image forming operation is performed to form an image only on one side of the recording sheet 5, the recording sheet 5 on which the fixing has been finished is finally discharged to the discharge tray 56, installed in the upper portion of the apparatus body 1a, by the sheet discharge roller pair 57.

When images are to be formed on both sides of the recording sheet 5, the recording sheet 5 having an image formed on one side thereof is not discharged to the discharge tray 56 by the sheet discharge roller pair 57, and the rotation direction of the sheet discharge roller pair 57 is switched to the reverse rotation direction while the sheet discharge roller pair 57 is holding the trailing end of the recording sheet 5. The recording sheet 5 transported in the opposite direction by the sheet discharge roller pair 57 is transported to the duplex transport path 60 including the duplex transport roller pair 59 and the like, and is transported again to the sheet transport roller pair 54 with the front and back reversed. The sheet transport roller pair 54 sends and supplies the recording sheet 5 to the secondary transfer position in accordance with a transfer timing, forms an image on a back surface of the recording sheet 5, and discharges the recording sheet 5 having the image fixed on the back surface thereof to the discharge tray 56 provided in the upper portion of the apparatus body 1a by the sheet discharge roller pair 57.

By the above-described operation, the recording sheet 5 having the full-color image, formed by combining the toner images of the four colors, formed on one side or both sides thereof is output.

### <Configuration of Developing Device>

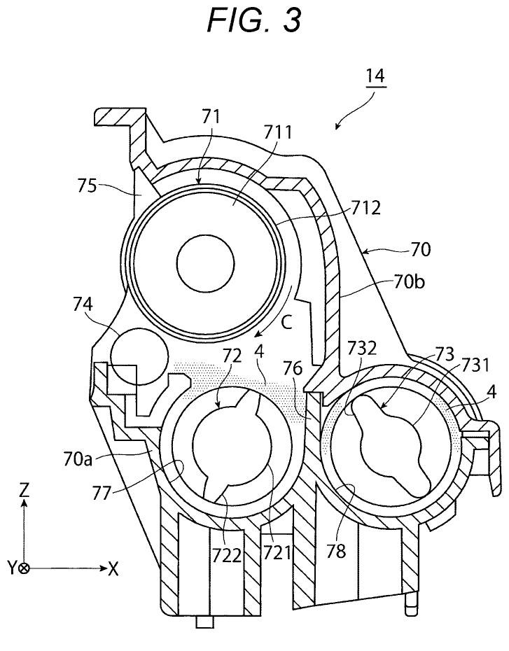

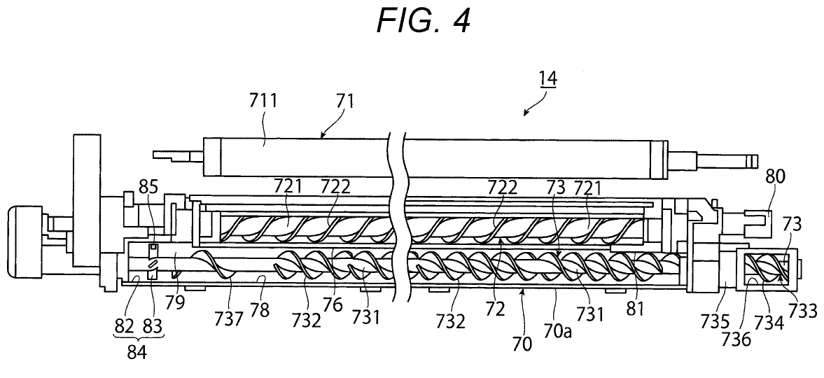

FIGS. 3 and 4 illustrate the developing device according to the first embodiment that is applied to the image forming apparatus configured as described above. FIG. 3 is a longitudinal cross-sectional view illustrating the configuration of the developing device, and FIG. 4 is a plan view illustrating the configuration in which a member covering an upper portion of the developing device is detached and a position of the developing roller is shifted.

As illustrated in FIG. 3, the developing device 14 according to the first embodiment includes the housing 70 formed in an elongated airtight box shape having a substantially rectangular cross section. The housing 70 of the developing device 14 mainly includes a lower housing 70a disposed below along the vertical direction Z and an upper housing 70b disposed above along the vertical direction Z.

A left side surface of the housing 70 has an opening 75 which is opened along the axial direction (the depth direction Y) of the photosensitive drum 11 in a region opposing the photosensitive drum 11 from an upper end portion of the lower housing 70a to the upper housing 70b.

Inside the housing 70, provided are: the developing roller 71 which is an example of a rotatable developer holding unit disposed so as to be partially exposed to the outside through the opening 75; the stirring supply member 72 including a screw auger or the like which is an example of a stirring supply unit rotatably disposed below the developing roller 71; the stirring transport member 73 including a screw auger or the like which is an example of a developer transport unit rotatably disposed on the back side of the stirring supply member 72; and the layer thickness regulating member 74 that has a columnar shape and is disposed below the developing roller 71 near the opening 75 and regulates the layer thickness of the developer 4 held on the surface of the developing roller 71.

Inside the housing 70, a first developer accommodating chamber 77 having a substantially semi-cylindrical cross-sectional shape and a second developer accommodating chamber 78 having a cylindrical cross-sectional shape, which are partitioned by a partition wall 76 dividing the stirring supply member 72 and the stirring transport member 73 are provided. The two-component developer 4 including a non-magnetic toner and a carrier is accommodated inside each of the first and second developer accommodating chambers 77 and 78.

The stirring supply member 72 is rotatably disposed in the first developer accommodating chamber 77. In addition, the stirring transport member 73 is rotatably disposed in the second developer accommodating chamber 78.

As illustrated in FIG. 3, the developing roller 71 includes: a magnet roller 711 which is disposed in a state of being fixed inside the developing roller 71 and includes a plurality of magnetic poles having predetermined polarities and disposed at predetermined positions along a circumferential direction; and a cylindrical developing sleeve 712 which is rotatably disposed on an outer periphery of the magnet roller 711 and rotates along a direction of an arrow C in a state of holding chains of the developer 4 on the surface. As described above, the layer thickness regulating member 74 having a columnar cross-sectional shape is provided below the developing roller 71 to regulate the layer thickness of the developer 4 supplied from the stirring supply member 72 to the surface of the developing roller 71.

As illustrated in FIGS. 3 and 4, the stirring supply member 72 includes a screw auger having a rotation shaft 721 formed into a columnar shape having a larger outer diameter than a rotation shaft 731 of the stirring transport member 73 using a synthetic resin or the like, and a spiral transport blade 722 integrally provided on an outer periphery of the rotation shaft 721. In the stirring supply member 72, at least a part of the rotation shaft 721 and the transport blade 722, for example, a part of the rotation shaft 721 may be formed using a metal material such as stainless steel.

As illustrated in FIG. 4, the transport blade 722 of the stirring supply member 72 stirs and transports the developer 4, which is transported from the stirring transport member 73 through a first communication hole 79 opened at an end portion on the front side of the partition wall 76, to the rear side (right side in FIG. 4) in an axial direction, and supplies the developer 4, which is transported by the transport blade 722, to the developing roller 71 (see FIG. 3). A length of the transport blade 722 of the stirring supply member 72 along the axial direction is set to be longer than that of the development region of the developing roller 71.

In FIG. 4, reference 80 denotes a coupling portion that is provided in a state of protruding to the rear side from an end portion of the housing 70 in a longitudinal direction and transmits a rotational driving force from the driving device (not illustrated) provided in the apparatus body la to the rotation shaft 721 of the stirring supply member 72 when the developing device 14 is mounted to the apparatus body 1a. Note that the rotational driving force is transmitted to the developing roller 71 from the apparatus body 1a separately from the stirring supply member 72.

The developer 4 transported to an end portion on the rear side along the axial direction by the stirring supply member 72 is delivered to the stirring transport member 73 via the second communication hole 81 opened in the partition wall 76.

As illustrated in FIGS. 3 and 4, the stirring transport member 73 includes a screw auger having the rotation shaft 731 formed into a columnar shape having the smaller outer diameter than the rotation shaft 721 of the stirring supply member 72 using a synthetic resin or the like, and a spiral transport blade 732 integrally provided on an outer periphery of the rotation shaft 731. In the stirring transport member 73, at least a part of the rotation shaft 731 and the transport blade 732, for example, a part of the rotation shaft 731 may be formed using a metal material such as stainless steel.

As illustrated in FIG. 4, the stirring transport member 73 includes the transport blade 732 provided in a double spiral shape with a small pitch in order to improve stirring performance for the developer 4. In addition, in the stirring transport member 73, the transport blade 732 having the double spiral shape is divided into a plurality of regions along an axial direction, and the transport blades 732 in the respective regions are disposed so as to be out of phase with each other by 90 degrees along a circumferential direction of the rotation shaft 731.

The stirring transport member 73 is extended such that an end portion on the rear side (right side in the drawing) along the axial direction thereof protrudes from the end portion of the housing 70. In an extension portion 733 of the stirring transport member 73, a transport blade 734 is provided on the outer periphery of the rotation shaft 731, and an outer periphery of the extension portion 733 is covered with a cylindrical toner supply portion 735 whose end portion is closed. The toner supply portion 735 has, in an upper surface thereof, a toner supply port 736 through which a toner containing a carrier are supplied from the toner cartridge 145 (Y, M, C, or K).

The toner containing the carrier supplied from the toner supply port 736 is transported into the housing 70 by the transport blade 734 provided on the extension portion 733 of the stirring transport member 73.

In addition, a delivery transport blade 737 for delivering the developer 4 transported by the transport blade 732 to the stirring supply member 72 via the first communication hole 79 is provided at an end portion on the front side (left side in the drawing) along the axial direction of the stirring transport member 73. The delivery transport blade 737 is formed in a single spiral shape so as to quickly and efficiently transport the developer 4 along the axial direction of the stirring transport member 73 unlike the transport blade 732, and has a pitch set to be larger than that of the transport blade 732.

Meanwhile, the developing device 14 configured as described above is known to be gradually degraded as the developer 4 is transported by the stirring supply member 72 and the stirring transport member 73 to circulate and move inside the housing 70 and the carrier in the developer 4 is rubbed against the toner during repetitions of a development step of developing an electrostatic latent image formed on each of the photosensitive drums 11, resulting in deterioration of a charging property for frictionally charging the toner, deterioration of fluidity of the developer 4 due to changes in aggregation characteristics of the initial state where the developer 4 is new, and deterioration of developing characteristics over time.

In this regard, the developing device 14 according to the first embodiment supplies the toner containing the carrier from each of the toner cartridges 145 (Y, M, C, and K), and the volume of the developer 4 (carrier) in the developing device 14 gradually increases and the amount of the developer in the developing device 14 is saturated as the toner containing the carrier that is not consumed in the development step is supplied into the housing 70 of the developing device 14. For this reason, the developing device 14 is provided with a developer discharge unit that discharges a part of the saturated developer 4 containing the carrier to the outside and employs a so-called trickle development system in which the developer 4 (carrier) in the housing 70 of the developing device 14 is replaced with the new developer 4 to resultantly maintain the developer 4 in the housing 70 at a constant amount, thereby preventing or suppressing the deterioration of the developing characteristics accompanying the degradation of the developer 4.

That is, as illustrated in FIG. 4, the developing device 14 according to the first embodiment includes a developer discharge unit 84 in which a reverse transport blade 83 that transports the developer 4 in a direction opposite to the discharge direction is disposed inside a reversing passage 82 located at the end portion on the front side which is the downstream side along a transport direction (the axial direction) of the stirring transport member 73. Here, the reversing passage 82 indicates a passage portion of the second developer accommodating chamber 78 in which the reverse transport blade 83 is disposed to transport the developer 4 to the rear side which is the direction opposite to the transport direction of the stirring transport member 73.

The developer 4 in the second developer accommodating chamber 78 in which the stirring transport member 73 is accommodated is typically transported to the end portion on the front side along the axial direction by the transport blade 732 and the delivery transport blade 737 of the stirring transport member 73. Typically, the developer 4 is entirely transported (pushed back) in the direction opposite to the discharge direction by the reverse transport blade 83 provided integrally with the stirring transport member 73, and is delivered to the stirring supply member 72 via the first communication hole 79.

However, a certain percentage of carrier is supplied into the housing 70 of the developing device 14 together with a new toner by the trickle development system as described above. Unlike the toner, the carrier supplied together with the toner into the housing 70 of the developing device 14 is not consumed in the development step and remains in the housing 70.

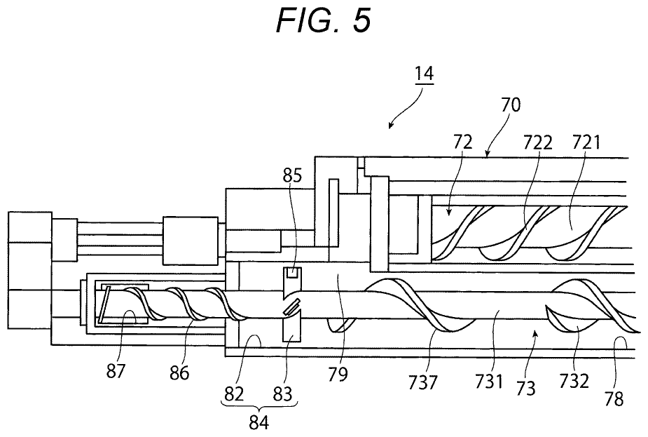

As a result, the volume of the developer 4 (carrier) in the housing 70 gradually increases, and the amount of the developer in the housing 70 exceeds a set upper limit value and is saturated in the developing device 14. When the amount of the developer in the housing 70 is saturated, it is difficult for the developing device 14 to transport (push back) the entire developer 4 in the direction opposite to the discharge direction by the reverse transport blade 83, and as illustrated in FIG. 5, a part of the developer 4 climbs over the reverse transport blade 83 by a transport force of the delivery transport blade 737 and is discharged to the outside through a trickle discharge port 87 by the discharge transport blade 86 disposed on the downstream side of the reverse transport blade 83. Note that the developer discharged to the outside through the trickle discharge port 87 is collected by a collecting device (not illustrated) disposed on the front side of the image forming apparatus 1.

In this manner, the developing device 14 employing the trickle development system resultantly maintains the total amount of the developer 4 accommodated in the housing 70 at a substantially constant amount while replacing a part of the carrier in the developer 4 existing in the housing 70 with a new carrier, thereby preventing or suppressing the deterioration of the developing characteristics accompanying the degradation of the developer 4.

However, from studies of the present inventors and the like, it has been found that, conventionally the developing device 14 employing the trickle development system has a new technical problem that trouble occurs because that the amount of the developer 4 that needs to be discharged from the trickle discharge port 87 after passing through the reverse transport blade 83 is affected by a change in the fluidity of the developer 4, it is difficult to maintain the amount of the developer in the housing 70 at a substantially constant amount, and the amount of the developer reaches an abnormal amount to cause trouble.

Main factors that cause the amount of the developer in the housing 70 to vary by the trickle development system include a change in the internal pressure of the developing device 14, a change in a toner concentration (TC) of the developer 4, and a change in the fluidity of the developer 4 depending on whether the developer 4 is new or degraded. In particular, in a case where the toner concentration (TC) of the developer 4 is low and the developer 4 is new and has high fluidity, a discharge amount of the developer 4 by the trickle development system increases from a normal state, and a developing amount in the developing device 14 tends to decrease below an allowable value, so that a new technical problem arises in that an auger mark is generated in an image to be developed or the inside of the apparatus body 1a is contaminated due to generation of a toner cloud caused by stirring failure of the developer 4.

Here, a state where the developer 4 is new literally includes a case where the developing device 14 has just started to newly use the developer 4, a case where a relatively large amount of a toner containing a carrier is continuously supplied into the housing 70 of the developing device 14, and the like.

On the other hand, in a case where the toner concentration (TC) of the developer 4 is high and the developer 4 is degraded, the fluidity of the developer 4 is lowered, the discharge amount of the developer 4 by the trickle development system decreases, and the developing amount in the developing device 14 tends to increase above an upper limit value, so that a new technical problem arises in that there is a possibility that the developer 4 may leak from the developing device 14 or a drive gear that rotationally drives the stirring supply member 72 and the stirring transport member 73 may be damaged due to an increase in torque.

In order to solve such new technical problems, as disclosed in JP2021-039287A or the like described as the related art, there is already proposed a configuration in which a magnetic field generation portion disposed on a downstream side of an upstream end of a discharge port in a direction in which a developer is conveyed in a discharge conveyance portion is provided.

However, a developing device according to JP2021-039287A merely decreases the amount of the developer discharged from the developing device by a trickle development system by providing the magnetic field generation portion disposed at the discharge port, and cannot cope with a variation in the amount of the developer in the developing device (particularly, an increase in the amount of the developer) caused by a change in the amount of the developer discharged from the developing device due to a change in the fluidity of the developer.

In this regard, in order to suppress the variation in the amount of the developer in the developing device 14 caused by the change in the amount of the developer discharged from the developing device 14, the developing device 14 according to the first embodiment of the present invention includes a developer discharge unit provided at an end portion on a downstream side along a transport direction of a developer transport unit and including a reverse transport blade that is disposed inside a reversing passage from which a part of the developer is discharged, and transports the developer in a direction opposite to a discharge direction, the developer discharge unit including a magnetic attraction unit magnetically attracting the developer in at least one of the reverse transport blade or the reversing passage.

That is, as illustrated in FIG. 4, the developing device 14 according to the first embodiment includes the developer discharge unit 84 including the reverse transport blade 83 that is disposed inside the reversing passage 82, which is provided at the end portion on the downstream side along the transport direction of the stirring transport member 73 and from which a part of the developer 4 is discharged, and transports the developer 4 in the direction opposite to the discharge direction, the developer discharge unit 84 including a magnetic attraction unit 85 magnetically attracting the developer 4 in the reverse transport blade 83.

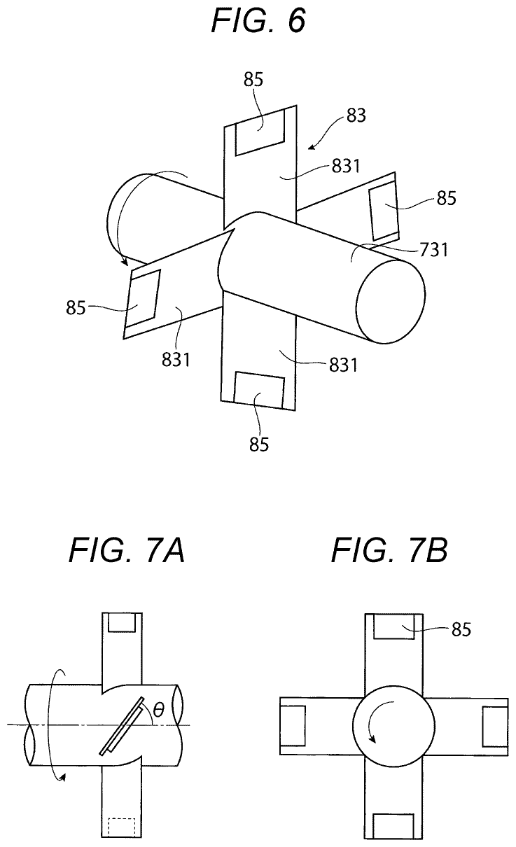

As illustrated in FIGS. 6 to 7B, the reverse transport blade 83 is formed by disposing a plurality of (four in the illustrated example) blades 831, 831, and so on in a windmill shape, and a portion to which the magnetic attraction unit 85 is added includes a flat plate. Each of the plurality of blades 831, 831, and so on constituting the reverse transport blade 83 is formed using a flat plate having a planar rectangular shape in which a length along a radial direction is set to be relatively longer than a width along a circumferential direction. The plurality of blades 831, 831, and so on are made of, for example, a synthetic resin, and are provided integrally with the rotation shaft 731 of the stirring transport member 73. In addition, the plurality of blades 831, 831, and so on are disposed on the outer periphery of the rotation shaft 731 so as to form an angle of 90 degrees with each other as illustrated in FIG. 7B in a state of being inclined by a predetermined inclination angle 0 with respect to the axial direction of the rotation shaft 731 of the stirring transport member 73 as illustrated in FIG. 7A.

As a result, as illustrated in FIG. 4, the plurality of blades 831, 831, and so on constituting the reverse transport blade 83 rotate integrally with the rotation shaft 731 of the stirring transport member 73, thereby transporting the developer 4 existing inside the reversing passage 82 in the direction opposite to the transport direction of the stirring transport member 73, that is, to the rear side (right side in FIG. 4) along the axial direction of the stirring transport member 73 according to the inclination angles of the blades 831, 831, and so on.

Note that the blades 831 constituting the reverse transport blade 83 are not limited to a flat plate shape, and may be formed in a spiral shape similarly to the transport blade 732 of the stirring transport member 73. The number of the blades 831 constituting the reverse transport blade 83 is not limited to four, and may be smaller or larger than four.

Meanwhile, when flat plate-shaped blades are used as the blades 831 constituting the reverse transport blade 83, it becomes easy to provide the magnetic attraction unit 85 on the surface of the blade 831 as follows.

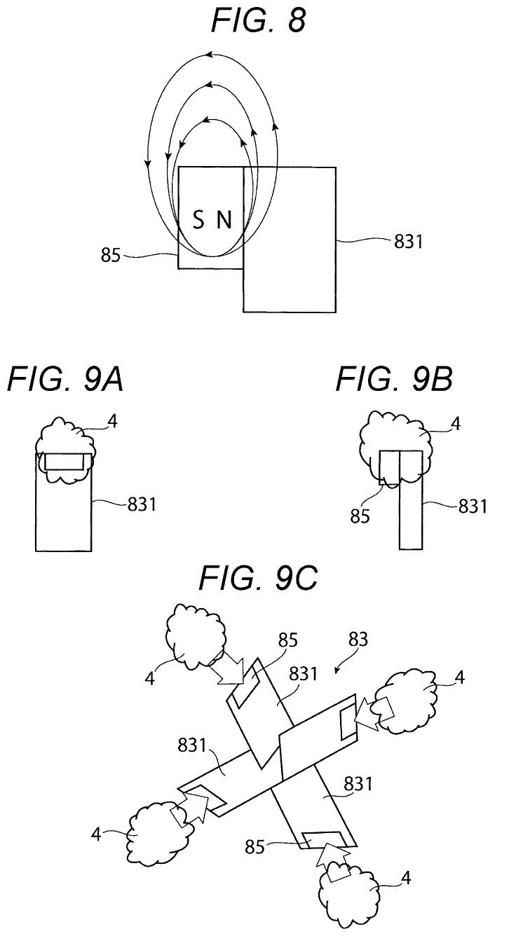

As illustrated in FIGS. 6 to 7B, each of the plurality of blades 831, 831, and so on is provided with a magnet 85, which is an example of the magnetic attraction unit, at an end portion on the outer peripheral side of the surface thereof by a method of adhesion or the like. As illustrated in FIG. 8, the magnet 85 is formed in a flat plate having a planar rectangular shape with a predetermined thickness, and an N pole having a predetermined magnetic force as a magnetic pole is magnetized on one surface side and an S pole having a predetermined magnetic force as another magnetic pole is magnetized on another surface side along a thickness direction which is the transport direction of the reverse transport blade 83. As a result, the magnet 85 is formed such that lines of magnetic force corresponding to the magnetic forces of the N pole and the S pole extend outward and inward in the radial direction of the blades 831, 831, and so on from the N pole side which is one surface of the blades 831, 831, and so on toward the S pole side which is the other surface.

According to the first embodiment, each of the magnets 85 is disposed on the outer peripheral side of the reverse transport blade 83, and thus, the discharge amount of the developer 4 can be reliably adjusted as compared with a case where each of the magnets 85 is disposed on the inner peripheral side of the reverse transport blade 83.

In addition, since the N poles and the S poles which are the magnetic poles of the magnets 85 provided in the reverse transport blade 83 are disposed along the thickness direction which is the transport direction of the reverse transport blade 83 according to the first embodiment, the chain of the carrier of the developer 4 is easily formed, and the discharge amount of the developer 4 transported by the reverse transport blade 83 is easily adjusted as compared with a case where the magnetic poles of the magnets 85 are disposed in the radial direction of the reverse transport blade 83.

As illustrated in FIGS. 9A to 9C, the developer 4 located inside the reversing passage 82 is magnetically attracted to the magnets 85 provided on the plurality of blades 831, 831, and so on.

In addition, the plurality of blades 831, 831, and so on constituting the reverse transport blade 83 are disposed inside the reversing passage 82, and are driven to rotate together with the rotation shaft 731 of the stirring transport member 73 in a state where the developer 4 is attracted to the magnets 85 provided on outer peripheral sides thereof. At this time, the plurality of blades 831, 831, and so on of the reverse transport blade 83 are disposed such that outer peripheral ends thereof oppose an inner peripheral surface of the reversing passage 82 with a predetermined gap therebetween.

Therefore, when the amount of the developer 4 that is magnetically attracted to and held by the magnets 85 provided on the outer peripheral sides of the plurality of blades 831, 831, and so on changes depending on the toner concentration (TC) of the developer 4 or the like, transport characteristics of the reverse transport blade 83 when the reverse transport blade 83 transports the developer 4 present inside the reversing passage 82 in the opposite direction change.

The toner concentration (TC) of the developer 4 accommodated in the housing 70 of the developing device 14 changes depending on, for example, a potential corresponding to an image density of an electrostatic latent image to be developed on the surface of the photosensitive drum 11, an amount and a timing of the toner containing the carrier supplied into the housing 70, and transport characteristics of the stirring transport member 73.

When the toner concentration (TC) of the developer 4 is lower than an assumed first threshold (for example, 3 to 4%) and the developer 4 is new and has high fluidity, the reverse transport blade 83 functions to decrease the amount of the developer 4 discharged from the reversing passage 82.

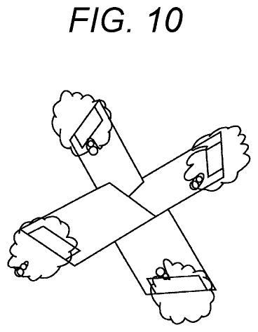

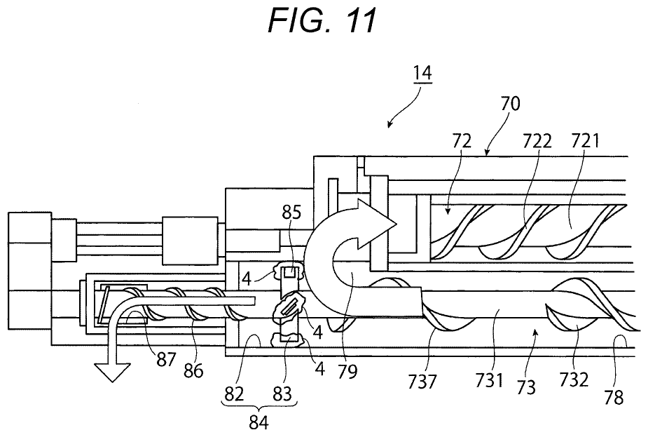

More specifically, when the toner concentration (TC) of the developer 4 is lower than the first threshold serving as a reference and the developer 4 is new and has high fluidity, the amount of the developer 4 magnetically attached to the magnets 85 of the reverse transport blade 83 increases as illustrated in FIG. 10. Therefore, when the reverse transport blade 83 is rotationally driven inside the reversing passage 82, as illustrated in FIG. 11, the toner concentration (TC) is lower than the first threshold and a carrier concentration is relatively high in the developer 4 present inside the reversing passage 82, and thus, a large amount of the developer 4 containing a large amount of the carrier including magnetic particles adheres to the magnet 85 of the reverse transport blade 83, and the amount of the developer 4 discharged over the reverse transport blade 83 decreases. Therefore, when the toner concentration (TC) of the developer 4 is lower than the assumed first threshold, the reverse transport blade 83 can reliably decrease the amount of the developer 4 discharged from the reversing passage 82 as compared with a case where the amount of the developer 4 discharged from the reversing passage 82 is increased.

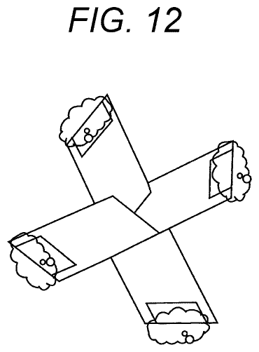

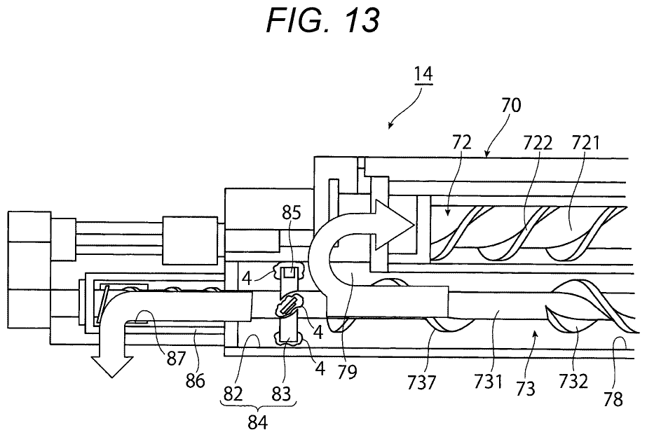

On the other hand, when the toner concentration (TC) of the developer 4 is relatively higher than a second threshold (for example, 9 to 10%) serving as a reference and the developer 4 is degraded, the amount of the developer 4 magnetically attached to the magnets 85 of the reverse transport blade 83 decreases as illustrated in FIG. 12. Therefore, when the reverse transport blade 83 is rotationally driven inside the reversing passage 82, as illustrated in FIG. 13, the toner concentration (TC) is higher than the second threshold and the carrier concentration is relatively low in the developer 4 present inside the reversing passage 82, and thus, a small amount of the developer 4 with a small amount of the carrier including magnetic particles adheres to the magnet 85 of the reverse transport blade 83, and the amount of the developer 4 discharged over the reverse transport blade 83 increases. Therefore, when the toner concentration (TC) of the developer 4 is higher than the assumed second threshold, the reverse transport blade 83 can reliably increase the amount of the developer 4 discharged from the reversing passage 82 as compared with a case where the amount of the developer 4 discharged from the reversing passage 82 is reduced.

### <Operation of Developing Device>

In the above-described configuration, the developing device according to the first embodiment can suppress a variation in the amount of the developer in the developing device caused by discharge of the developer from the developer discharge unit due to a change in a toner concentration of the developer in the developing device as compared with a case where the developer discharge unit having the magnetic attraction unit that magnetically attracts the developer in at least one of the reverse transport blade or the reversing passage is not provided in the following manner.

That is, in the image forming apparatus 1 to which the developing device according to the first embodiment is applied, as illustrated in FIGS. 1 and 2, electrostatic latent images formed on the surfaces of the photosensitive drums 11 (Y, M, C, and K) are developed by the toners of the corresponding colors of the developing devices 14 (Y, M, C, and K), and the toners in the developers 4 accommodated inside the housings 70 of the developing device 14 are consumed in the image forming devices 10 (Y, M, C, and K) of yellow (Y), magenta (M), cyan (C), and black (K).

Therefore, in the image forming apparatus 1 configured as described above, the toner of the corresponding color containing the carrier is supplied from the toner cartridge 145 (Y, M, C, or K) into the housing 70 of the developing device 14 at a predetermined timing in accordance with the toner concentration (TC) in the developing device 14 (Y, M, C, or K) as illustrated in FIG. 1.

As illustrated in FIGS. 3 and 4, while the toner containing the carrier supplied into the housing 70 of the developing device 14 is transported in the axial direction by the transport blade 732 of the stirring transport member 73, the toner is sufficiently stirred with the developer 4 accommodated in the housing 70 and is frictionally charged, is delivered to the stirring supply member 72 via the first communication hole 79, is further stirred and transported by the stirring supply member 72, and is supplied to the developing roller 71.

Meanwhile, as illustrated in FIG. 4, the developer discharge unit 84 including the reverse transport blade 83 is provided at the end portion on the downstream side along the transport direction of the stirring transport member 73 inside the housing 70 of the developing device 14.

When the total amount of the developer 4 accommodated in the housing 70 of the developing device 14 is within an appropriate range, the developer 4 is transported to the end portion on the downstream side along the transport direction by the transport blade 732 and the delivery transport blade 737 of the stirring transport member 73, then transported (pushed back) to the rear side in the direction opposite to the transport direction of the delivery transport blade 737 by the reverse transport blade 83, and delivered to the stirring supply member 72 via the first communication hole 79.

Thereafter, when the amount of the toner containing the carrier supplied into the housing 70 of the developing device 14 by the trickle development system increases, the volume of the developer 4 (carrier) in the housing 70 of the developing device 14 gradually increases, and the amount of the developer in the housing 70 exceeds the set upper limit value and is saturated. When the amount of the developer in the housing 70 is saturated, it is difficult for the developing device 14 to transport (push back) the entire developer 4 in the direction opposite to the discharge direction by the reverse transport blade 83, and a part of the developer 4 climbs over the reverse transport blade 83 by the transport force of the delivery transport blade 737 and is discharged to the outside through the trickle discharge port 87 by the discharge transport blade 86 disposed on the downstream side of the reverse transport blade 83.

At this time, when the toner concentration (TC) of the developer 4 accommodated in the developing device 14 is low and the developer 4 is new and has high fluidity, the amount of the developer 4 magnetically attached to the magnets 85 of the reverse transport blade 83 increases as illustrated in FIG. 10. Therefore, when the reverse transport blade 83 is rotationally driven inside the reversing passage 82, as illustrated in FIG. 11, the toner concentration (TC) is lower than the first threshold and a carrier concentration is relatively high in the developer 4 present inside the reversing passage 82, and thus, a large amount of the developer 4 containing a large amount of the carrier including magnetic particles adheres to the magnet 85 of the reverse transport blade 83, and the amount of the developer 4 discharged over the reverse transport blade 83 decreases.

As a result, in a case where the toner concentration (TC) of the developer 4 accommodated in the developing device 14 is low and the developer 4 is new and has high fluidity, the decrease in the developing amount in the developing device 14 below the allowable value due to the increase in the discharge amount of the developer 4 by the trickle development system from the normal state, the generation of the auger mark in the image to be developed, and the contamination of the inside of the apparatus body 1a due to the generation of the toner cloud caused by the stirring failure of the developer 4, which are conventional problems, are prevented or suppressed.

On the other hand, when the toner concentration (TC) of the developer 4 is relatively higher than the second threshold serving as the reference and the developer 4 is degraded, the amount of the developer 4 magnetically attached to the magnets 85 of the reverse transport blade 83 decreases as illustrated in FIG. 12. Therefore, when the reverse transport blade 83 is rotationally driven inside the reversing passage 82, as illustrated in FIG. 13, the toner concentration (TC) is higher than the second threshold and the carrier concentration is relatively low in the developer 4 present inside the reversing passage 82, and thus, a small amount of the developer 4 with a small amount of the carrier including magnetic particles adheres to the magnet 85 of the reverse transport blade 83, and the amount of the developer 4 discharged over the reverse transport blade 83 increases.

As a result, in a case where the toner concentration (TC) of the developer 4 is high and the developer 4 is degraded, the decrease in the fluidity of the developer 4, the increase in the developing amount in the developing device 14 above the upper limit value due to the decrease in the discharge amount of the developer 4 by the trickle development system, the leakage of the developer 4 from the developing device 14, and the damage of the drive gear that rotationally drives the stirring supply member 72 and the stirring transport member 73 due to the increase in torque, which are conventional problems, are prevented or suppressed.

Note that, when the toner concentration (TC) of the developer 4 is equal to or higher than the first threshold and equal to or lower than the second threshold, and the developer 4 is in a medium use state, the amount of the developer 4 magnetically attached to the magnet 85 of the reverse transport blade 83 becomes an appropriate value, and the reverse transport blade 83 is rotationally driven inside the reversing passage 82, so that the developer 4 corresponding to the saturated amount of the developer 4 is discharged to the outside, and good developing characteristics by the developing device 14 are maintained.

As described above, the developing device 14 according to the first embodiment can suppress a variation in the amount of the developer in the developing device caused by the discharge of the developer from the developer discharge unit due to a change in the toner concentration of the developer in the developing device as compared with a case where the developer discharge unit 84 having the magnetic attraction unit 85 that magnetically attracts the developer 4 in the reverse transport blade 83 is not provided.

### Second Embodiment

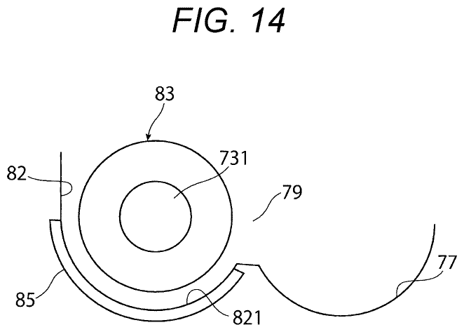

FIG. 14 is a view illustrating a configuration of the main portion of a developing device according to a second embodiment of the present invention. In the developing device according to the second embodiment, a magnetic attraction unit is added to a reversing passage. In addition, the reversing passage has a semi-cylindrical portion formed in a semi-cylindrical shape to accommodate a reverse transport blade, and the magnetic attraction unit is added in a state of being embedded in an interior wall of the semi-cylindrical portion. Note that the same members as those in the first embodiment will be denoted by the same references.

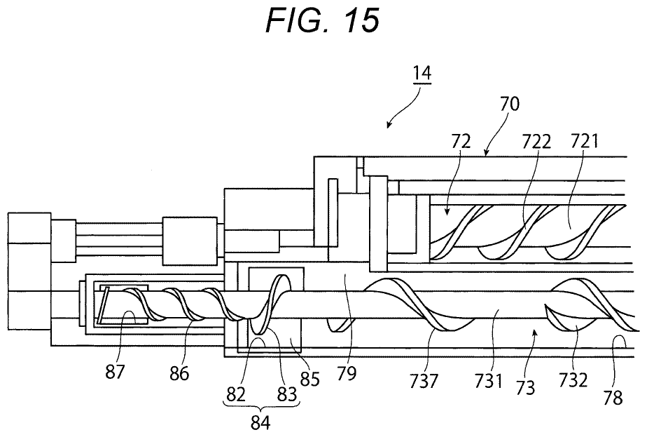

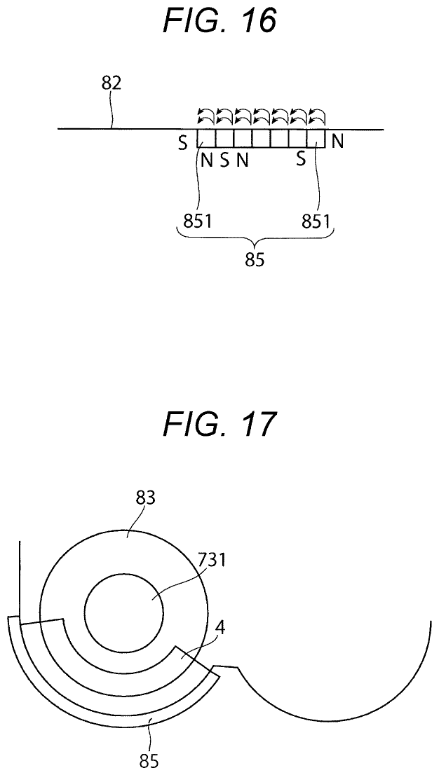

That is, as illustrated in FIGS. 14 and 15, the developing device 14 according to the second embodiment includes, as the reverse transport blade, a reverse screw auger 83 formed in a spiral shape differently from that of the first embodiment. The reversing passage 82 has a semi-cylindrical portion 821 formed in a semi-cylindrical shape to accommodate the reverse screw auger 83.

In the developing device 14 according to the second embodiment, the magnet 85, which is an example of a magnetic attraction unit, is embedded in the interior wall of the semi-cylindrical portion 821 of the reversing passage 82. The magnet 85 is formed in a shape forming a part of a cylindrical shape having a radius of curvature equal to that of the interior wall of the semi-cylindrical portion 821 of the reversing passage 82.

Here, the term “embedded” means a state in which the magnet 85 is buried in the semi-cylindrical portion 821 of the reversing passage 82, and an inner peripheral surface of the magnet 85 is disposed so as to form the same surface as an inner peripheral surface of the semi-cylindrical portion 821 of the reversing passage 82. That is, it does not mean that the magnet 85 is buried in the inside such that the inner peripheral surface thereof is not exposed from the semi-cylindrical portion 821 of the reversing passage 82. Since the inner peripheral surface of the magnet 85 is exposed at the surface of the semi-cylindrical portion 821 of the reversing passage 82, a magnetic force of the magnet 85 can effectively act on the developer 4 present in the semi-cylindrical portion 821 of the reversing passage 82.

As illustrated in FIG. 15, the magnet 85 is formed by stacking a plurality of thin plate-shaped magnets 851 each having an N pole and an S pole magnetized along a transport direction of the reverse screw auger 83.

In the above-described configuration, when the amount of a toner containing a carrier supplied into the housing 70 of the developing device 14 by a trickle development system increases, the volume of the developer 4 (carrier) in the housing 70 of the developing device 14 gradually increases, and the amount of the developer in the housing 70 exceeds a set upper limit value and is saturated in the developing device 14 according to the second embodiment as in the developing device 14 according to the first embodiment. When the amount of the developer in the housing 70 is saturated, it is difficult for the developing device 14 to transport (push back) the entire developer 4 in a direction opposite to a discharge direction by the reverse screw auger 83, and a part of the developer 4 climbs over the reverse screw auger 83 by a transport force of the delivery transport blade 737 and is discharged to the outside through the trickle discharge port 87 by the discharge transport blade 86 disposed on the downstream side of the reverse screw auger 83.

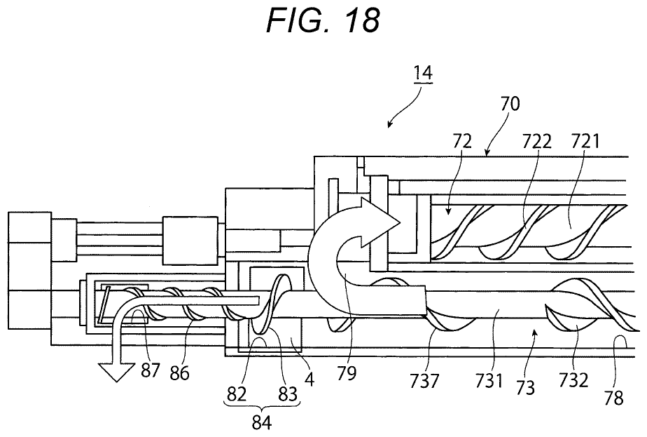

At this time, when the toner concentration (TC) of the developer 4 accommodated in the developing device 14 is low and the developer 4 is new and has high fluidity, the amount of the developer 4 magnetically attached to the magnet 85 embedded in the inner surface of the reversing passage 82 opposing the reverse screw auger 83 increases as illustrated in FIG. 17. Therefore, when the reverse screw auger 83 is rotationally driven in the reversing passage 82, as illustrated in FIGS. 17 and 18, since the developer 4 present inside the reversing passage 82 has a toner concentration (TC) lower than a first threshold and a relatively high carrier concentration, a large amount of the developer 4 containing a large amount of the carrier including magnetic particles adheres to the magnet 85 in the reversing passage 82, and the amount of the developer 4 discharged over the reverse screw auger 83 in the reversing passage 82 is reduced.

As a result, in a case where the toner concentration (TC) of the developer 4 accommodated in the developing device 14 is low and the developer 4 is new and has high fluidity, the decrease in the developing amount in the developing device 14 below the allowable value due to the increase in the discharge amount of the developer 4 by the trickle development system from the normal state, the generation of the auger mark in the image to be developed, and the contamination of the inside of the apparatus body 1a due to the generation of the toner cloud caused by the stirring failure of the developer 4, which are conventional problems, are prevented or suppressed.

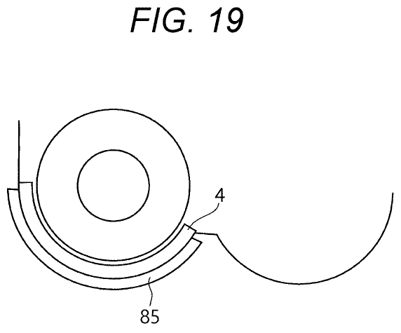

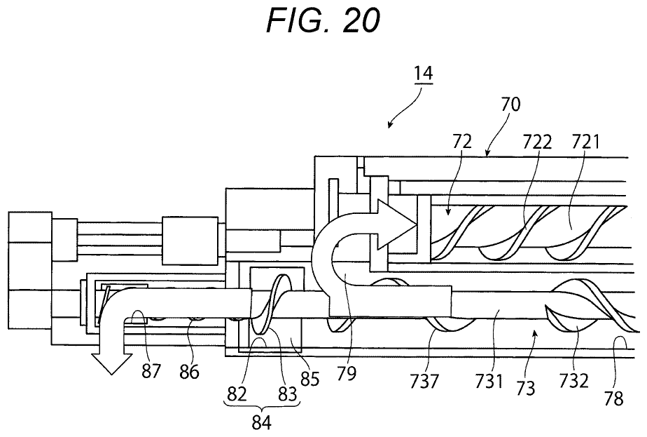

On the other hand, when the toner concentration (TC) of the developer 4 is relatively higher than a second threshold serving as a reference and the developer 4 is degraded, the amount of the developer 4 magnetically attached to the magnet 85 in the reversing passage 82 decreases as illustrated in FIG. 19. Therefore, when the reverse screw auger 83 is rotationally driven in the reversing passage 82, as illustrated in FIGS. 19 and 20, since the developer 4 present inside the reversing passage 82 has a toner concentration (TC) higher than the second threshold and a relatively low carrier concentration, a small amount of the developer 4 having a small amount of the carrier including the magnetic particles adheres to the magnet 85 in the reversing passage 82, and the amount of the developer 4 discharged over the reverse screw auger 83 increases.

As a result, in a case where the toner concentration (TC) of the developer 4 is high and the developer 4 is degraded, the decrease in the fluidity of the developer 4, the increase in the developing amount in the developing device 14 above the upper limit value due to the decrease in the discharge amount of the developer 4 by the trickle development system, the leakage of the developer 4 from the developing device 14, and the damage of the drive gear that rotationally drives the stirring supply member 72 and the stirring transport member 73 due to the increase in torque, which are conventional problems, are prevented or suppressed.

In the developing device 14 according to the second embodiment, since the magnet 85 is added to the reversing passage 82, it is sufficient to embed the magnet 85 in the inner peripheral surface of the reversing passage 82 so that it is easy to add the magnet 85 as compared with a case where the magnetic attraction unit is added to the reverse transport blade.

In the developing device 14 according to the second embodiment, since the magnet 85 is embedded in the semi-cylindrical portion 821 of the reversing passage 82, the magnet 85 is prevented from obstructing movement of the developer 4 as compared with a case where the magnetic attraction unit protrudes from the interior wall of the semi-cylindrical portion of the reversing passage 82.

Other configurations and effects are similar to those of the first embodiment, and thus, the description thereof will be omitted.

Although the case where the developer discharge unit is provided at the end portion on the downstream side along the axial direction of the stirring transport unit has been described in the above-described embodiment, the present invention is not limited thereto, and the developer discharge unit may be provided in the stirring supply unit.

In addition, the case where a full-color image forming apparatus is applied as the image forming apparatus has been described in the above-described embodiment, but the present invention is not limited thereto, and a monochrome image forming apparatus may be applied as the image forming apparatus.

### (Supplementary Notes)

(((1)))

A developing device comprising:

a developer transport unit that transports a developer containing a toner and a carrier; and

a developer discharge unit provided at an end portion on a downstream side along a transport direction of the developer transport unit and including a reverse transport blade that is disposed inside a reversing passage from which a part of the developer is discharged, and rotates around a rotation shaft to transport the developer in a direction opposite to a discharge direction, the developer discharge unit including a magnetic attraction unit magnetically attracting the developer in at least one of the reverse transport blade or the reversing passage.

(((2)))

The developing device according to (((1))), wherein the magnetic attraction unit is added to the reverse transport blade.

(((3)))

The developing device according to (((2))), wherein the reverse transport blade includes a plurality of blades disposed in a windmill shape, and a shape of a surface of the reverse transport blade to which the magnetic attraction unit is added corresponds to a shape of a surface of the magnetic attraction unit which comes into contact with the reverse transport blade.

(((4)))

The developing device according to (((3))), wherein the magnetic attraction unit is added to an outer peripheral side of each of the plurality of blades.

(((5)))

The developing device according to (((3))), wherein the magnetic attraction unit includes two magnetic poles of an N pole and an S pole, and the two magnetic poles are aligned in a developer transport direction of the reverse transport blade.

(((6)))

A developing device comprising:

a developer transport unit that transports a developer containing a toner and a carrier; and

a developer discharge unit provided at an end portion on a downstream side along a transport direction of the developer transport unit and including a reverse transport blade that is disposed inside a reversing passage from which a part of the developer is discharged, and rotates around a rotation shaft to transport the developer in a direction opposite to a discharge direction, the developer discharge unit decreasing an amount of the developer discharged from the reversing passage when a toner concentration of the developer is lower than a first threshold.

(((7)))

A developing device comprising:

a developer transport unit that transports a developer containing a toner and a carrier; and

a developer discharge unit provided at an end portion on a downstream side along a transport direction of the developer transport unit and including a reverse transport blade that is disposed inside a reversing passage from which a part of the developer is discharged, and rotates around a rotation shaft to transport the developer in a direction opposite to a discharge direction, the developer discharge unit increasing an amount of the developer discharged from the reversing passage when a toner concentration of the developer is higher than a second threshold.

(((8)))

The developing device according to (((1))), wherein the magnetic attraction unit is added to the reversing passage.

(((9)))

The developing device according to (((8))), wherein

the reversing passage includes a semi-cylindrical portion formed in a semi-cylindrical shape to accommodate the reverse transport blade, and

the magnetic attraction unit is added in a state of being embedded in an interior wall of the semi-cylindrical portion.

(((10)))

The developing device according to (((1))), further comprising:

a developer holding unit that holds the developer;

a stirring supply unit that supplies the developer to the developer holding unit while stirring the developer; and

a stirring transport unit that transports the developer to the stirring supply unit while stirring the developer,

wherein the developer transport unit includes the stirring transport unit.

(((11)))

The developing device according to (((10))), wherein the developer discharge unit is provided at an end portion on a downstream side along a transport direction of the stirring transport unit.

(((12)))

The developing device according to (((1))), further comprising a discharge transport unit that is disposed on a downstream side of the developer discharge unit along a transport direction of the developer and transports the developer to a discharge port.

(((13)))

An image forming apparatus comprising:

an image holding unit that holds an electrostatic latent image; and

a developing unit that develops the electrostatic latent image of the image holding unit,

wherein the developing device according to any one of (((1))) to (((12))) is used as the developing unit.

What is claimed is:

1. A developing device comprising:
a developer transport unit that transports a developer containing a toner and a carrier; and
a developer discharge unit provided at an end portion on a downstream side along a transport direction of the developer transport unit and including a reverse transport blade that is disposed inside a reversing passage from which a part of the developer is discharged, and rotates around a rotation shaft to transport the developer in a direction opposite to a discharge direction, the developer discharge unit including a magnetic attraction unit magnetically attracting the developer in at least one of the reverse transport blade or the reversing passage.

2. The developing device according to claim 1, wherein the magnetic attraction unit is added to the reverse transport blade.

3. The developing device according to claim 2, wherein the reverse transport blade includes a plurality of blades disposed in a windmill shape, and a shape of a surface of the reverse transport blade to which the magnetic attraction unit is added corresponds to a shape of a surface of the magnetic attraction unit which comes into contact with the reverse transport blade.

4. The developing device according to claim 3, wherein the magnetic attraction unit is added to an outer peripheral side of each of the plurality of blades.

5. The developing device according to claim 3, wherein the magnetic attraction unit includes two magnetic poles of an N pole and an S pole, and the two magnetic poles are aligned in a developer transport direction of the reverse transport blade.

6. A developing device comprising:
a developer transport unit that transports a developer containing a toner and a carrier; and
a developer discharge unit provided at an end portion on a downstream side along a transport direction of the developer transport unit and including a reverse transport blade that is disposed inside a reversing passage from which a part of the developer is discharged, and rotates around a rotation shaft to transport the developer in a direction opposite to a discharge direction, the developer discharge unit decreasing an amount of the developer discharged from the reversing passage when a toner concentration of the developer is lower than a first threshold.

7. A developing device comprising:
a developer transport unit that transports a developer containing a toner and a carrier; and
a developer discharge unit provided at an end portion on a downstream side along a transport direction of the developer transport unit and including a reverse transport blade that is disposed inside a reversing passage from which a part of the developer is discharged, and rotates around a rotation shaft to transport the developer in a direction opposite to a discharge direction, the developer discharge unit increasing an amount of the developer discharged from the reversing passage when a toner concentration of the developer is higher than a second threshold.

8. The developing device according to claim 1, wherein the magnetic attraction unit is added to the reversing passage.

9. The developing device according to claim 8, wherein
the reversing passage includes a semi-cylindrical portion formed in a semi-cylindrical shape to accommodate the reverse transport blade, and
the magnetic attraction unit is added in a state of being embedded in an interior wall of the semi-cylindrical portion.

10. The developing device according to claim 1, further comprising:
a developer holding unit that holds the developer;
a stirring supply unit that supplies the developer to the developer holding unit while stirring the developer; and
a stirring transport unit that transports the developer to the stirring supply unit while stirring the developer,
wherein the developer transport unit includes the stirring transport unit.

11. The developing device according to claim 10, wherein the developer discharge unit is provided at an end portion on a downstream side along a transport direction of the stirring transport unit.

12. The developing device according to claim 1, further comprising a discharge transport unit that is disposed on a downstream side of the developer discharge unit along a transport direction of the developer and transports the developer to a discharge port.

13. An image forming apparatus comprising:
an image holding unit that holds an electrostatic latent image; and
a developing unit that develops the electrostatic latent image of the image holding unit,
wherein the developing device according to claim 1 is used as the developing unit.

14. An image forming apparatus comprising:
an image holding unit that holds an electrostatic latent image; and
a developing unit that develops the electrostatic latent image of the image holding unit,
wherein the developing device according to claim 2 is used as the developing unit.

15. An image forming apparatus comprising:
an image holding unit that holds an electrostatic latent image; and
a developing unit that develops the electrostatic latent image of the image holding unit,
wherein the developing device according to claim 3 is used as the developing unit.

16. An image forming apparatus comprising:
an image holding unit that holds an electrostatic latent image; and
a developing unit that develops the electrostatic latent image of the image holding unit,
wherein the developing device according to claim 4 is used as the developing unit.

17. An image forming apparatus comprising:
an image holding unit that holds an electrostatic latent image; and
a developing unit that develops the electrostatic latent image of the image holding unit,
wherein the developing device according to claim 5 is used as the developing unit.

18. An image forming apparatus comprising:
an image holding unit that holds an electrostatic latent image; and
a developing unit that develops the electrostatic latent image of the image holding unit,
wherein the developing device according to claim 6 is used as the developing unit.

19. An image forming apparatus comprising:
an image holding unit that holds an electrostatic latent image; and
a developing unit that develops the electrostatic latent image of the image holding unit,
wherein the developing device according to claim 7 is used as the developing unit.

20. An image forming apparatus comprising:
an image holding unit that holds an electrostatic latent image; and
a developing unit that develops the electrostatic latent image of the image holding unit,
wherein the developing device according to claim 8 is used as the developing unit.
